(19) United States
(12) Patent Application Publication
(10) Pub. No.: US 2025/0207597 A1
(43) Pub. Date: Jun. 26, 2025

(54) Improving scale control for protecting electric submersible pumps

(71) Applicant: Saudi Arabian Oil Company, Dhahran (SA)

(72) Inventors: Qiwei Wang, Dhahran (SA); Rui F. Pessoa Rodrigues, Dammam (SA); Mohammed A. Al-Khalifah, Saihat (SA); Tao Chen, Dhahran (SA)

(21) Appl. No.: 18/391,987

(22) Filed: Dec. 21, 2023

(51) Int. Cl. F04D 13/10; C09D 1/00; C09D 5/16; E21B 43/12; F04D 13/08

(52) U.S. Cl. CPC F04D 13/10; C09D 1/00; C09D 5/1662; E21B 43/128; F04D 13/086

(57) ABSTRACT

A system and method is provided for reducing scale inhibitor demand for protecting an electrical submersible pump (ESP) for downhole service in a wellbore. An exemplary system includes a motor including a housing that houses a motor stator. The system also includes a pump intake coupled to a pump stage, wherein the pump stage includes an impeller and a diffuser, wherein the pump stage is operatively coupled to the motor stator. A substantially hydrophobic coating substantially covers each surface of the motor, motor stator, housing, pump stage, impeller, and diffuser, that is in direct contact with fluids in the wellbore.

### TECHNICAL FIELD

This disclosure relates to coating the internal components and surfaces of an electric submersible pump (ESP) with a hydrophobic coating to decrease the amount of scale inhibitor squeeze (SIS) used to protect the ESP from inorganic scale deposition.

### BACKGROUND

An electric submersible pump (ESP) can be used to pump produced fluids from a wellbore of a well (e.g., an oil well, a gas well) to the earth's surface. An ESP is prone of scale buildup but has low tolerance to deposition or fouling. Inorganic scale has been identified as one of the key issues that negatively affect the performance of an ESP. Inorganic scale can lead to the premature failures of the ESP. A scale inhibitor squeeze (SIS) treatment is commonly used for protecting ESP from inorganic scale deposition. However, an SIS treatment usually has short life, largely due to high level of inhibitor concentration required to control scaling process inside of ESP pump.

### SUMMARY

An embodiment described herein provides a system for reducing scale inhibitor demand for protecting an electrical submersible pump (ESP) for downhole service in a wellbore. The system includes a motor including a housing that houses a motor stator. The system also includes a pump intake coupled to a pump stage, wherein the pump stage includes an impeller and a diffuser, wherein the pump stage is operatively coupled to the motor stator. A substantially hydrophobic coating substantially covers each surface of the motor, motor stator, housing, pump stage, impeller, and diffuser, that is in direct contact with fluids in the wellbore.

Another embodiment described herein provides a method for extending scale inhibitor squeeze (SIS) treatment life in an electric submersible pump (ESP). The method includes performing an SIS treatment through the ESP, wherein the ESP includes a motor including a housing that houses a motor stator, and a pump intake coupled to a pump stage. The pump stage includes an impeller and a diffuser, wherein the pump stage is operatively coupled to the motor stator. A hydrophobic coating substantially covers each surface of the motor, motor stator, housing, pump stage, impeller, and diffuser, that is in direct contact with fluids in the wellbore. The concentration of the scale inhibitor is monitored in the produced fluids and the SIS treatment through the ESP is repeated when the scale inhibitor concentration falls below a minimum effective dose (MED). The MED is decreased by the hydrophobic coating by about 20% to about 80%.

### BRIEF DESCRIPTION OF DRAWINGS

FIG. 1 is a schematic diagram of scale formation in a production environment.

FIG. 2 is a schematic drawing of a scale inhibitor squeeze (SIS) treatment into a wellbore that has an ESP that has been coated with a hydrophobic or super hydrophobic coating.

FIG. 3 is a plot of scale inhibitor concentration over time, or cumulative volume of water produced.

FIG. 4 is a schematic drawing of a system that includes a hydrocarbon-producing well with a portion, the wellhead, above the earth's surface and a portion, including the wellbore below the earth's surface.

FIGS. 5A-5D are drawings of a pump used in an ESP.

FIGS. 6A and 6B are images of the scale deposits on the impellers and the pump intake.

FIG. 7 is a plot showing the reduction in the MED resulting from coating the parts of the ESP with a hydrophobic or super hydrophobic coating.

FIG. 8 is a plot of the water flow velocity profile for a turbulent boundary layer in a pump.

FIGS. 9A and 9B are plots of the water flow velocity in a turbulent boundary layer with hydrophilic and hydrophobic surfaces.

FIG. 10 is a plot of the scale inhibitor return profile in packed column test.

### DETAILED DESCRIPTION

Solids deposition in oil production systems can cause operational issues. For example, scale formation interferes with flow in hydrocarbon production and water injection, among others. Deposition of inorganic and organic solids in production systems impacts throughput and can cause other operational issues. Once formed, remediation of deposits is costly, often resulting in lost production. Scale inhibitor squeeze (SIS) treatments are commonly used to protect downhole equipment, such as electric submersible pumps (ESP). However, the SIS treatment usually has a short-lived, largely due to the high level of inhibitor concentration, or minimum effective dose (MED), required to control scaling inside of an ESP.

Systems and methods are provided herein to reduce the required inhibitor MED (minimum effective dose) level used to protect an ESP. The method includes applying a hydrophobic or superhydrophobic coating on parts of the ESP that is exposed to the downhole fluids, such as the impeller, the diffuser, the discharge, and the intake. The hydrophobic or superhydrophobic coating alters the hydrodynamics of flow in the boundary layer over the coated surface, which helps to prevent corrosion and erosion, slowing the kinetics of the scale nucleation and deposition process. The formation of an oil or gas film can also help to prevent the deposition of scale particles from the aqueous phase onto an exposed surface of the ESP. As a result, the MED is reduced, which extends the life of the SIS treatment. As the residual concentration of the scale inhibitor decreases slowly with time after the initial flowback, even a small reduction in MED value can translate to a significant increase in treatment life. The material used for the coating can be, but is not limited to,

functionalized diamond-like carbon (DLC). The wettability of DLC can be modified by doping light elements or incorporating nanoparticles which allows the hydrophobic nature the surface to be adjusted. The DLC is chemically inert, for example, not being reactive to CO₂, H₂S and other dissolved components in the produced fluids at high temperature. It is also resistant to erosion and corrosion and forms a strong bond with a steel substrate.

Although the DLC is a good choice for forming the coating, other materials can be used. For example, the parts of the ESP can be coated with a polymer material, such as polytetrafluoroethylene (PTFE), polyphenylene sulfide (PPS), or a modified version of these polymers, among others. Other coatings can include glass, ceramic, and the like.

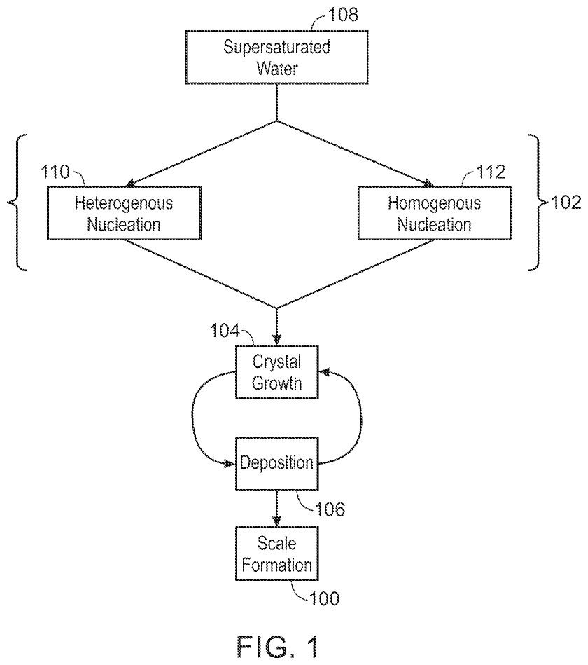

FIG. 1 is a schematic diagram of scale formation 100 in a production environment. Scale formation 100 is a complex process which involves several steps including nucleation 102, crystal growth 104, and deposition 106 in the supersaturated water 108 in the wellbore. These processes can proceed either in series or parallel. The nucleation 102 of solid, or scale, particles can occur either on a surface, for example, heterogeneous nucleation 110, or in bulk solution, for example, homogeneous nucleation 112. For the scale particles formed in bulk solution by homogenous nucleation 112, deposition onto surfaces in the ESP forms the scale deposit. If the scale particles do not deposit onto the surfaces, they remain suspended in the water, and do not harm production systems or equipment.

The deposition of scale particles can be affected by characteristics of the surfaces of the ESP, such as, smoothness, wettability, and the presence of corrosion products. Other characteristics that can affect the deposition include the composition of the surface, such as a metallic or non-metallic material. Further, the flow velocity and size and shape of the scale particle can affect the deposition. As described herein, coating the exposed surfaces of the ESP can lower heterogenous nucleation 110 and decrease the deposition of particles formed by homogenous nucleation 112 on pump surfaces.

A cost-effective approach to control the formation of inorganic scale on surfaces is the use of threshold scale inhibitors, such as phosphonates, polyacrylates, polymaleates, and the like. Threshold scale inhibitors can delay the nucleation rate, retard crystal growth, and change the shape of scale particles from regular to deformed irregular shape. Irregular solids are more difficult to attach on surface than smooth solids. These effects increase with scale inhibitor concentration.

The threshold scale inhibitors can delay or reduce scale formation when added in a small, or sub-stoichiometric, amount to scaling water. To be effective, the inhibitor must be present in the water continuously, so that it is available to inhibit the growth of each scale crystal as it precipitates from water. As described herein, the minimum level of inhibitor that will effectively prevent scale is termed the minimum effective dose (MED).

The threshold scale inhibitors are applied via either continuous chemical injection or through an intermittent treatment termed a scale inhibitor squeeze (SIS) treatment. The SIS treatment is performed by pushing the scale inhibitor solution into a producing formation and fixing the inhibitor in the formation. The scale inhibitor is then slowly released into the production water, maintaining the concentration. When the concentration drops below the MED, the SIS treatment is repeated.

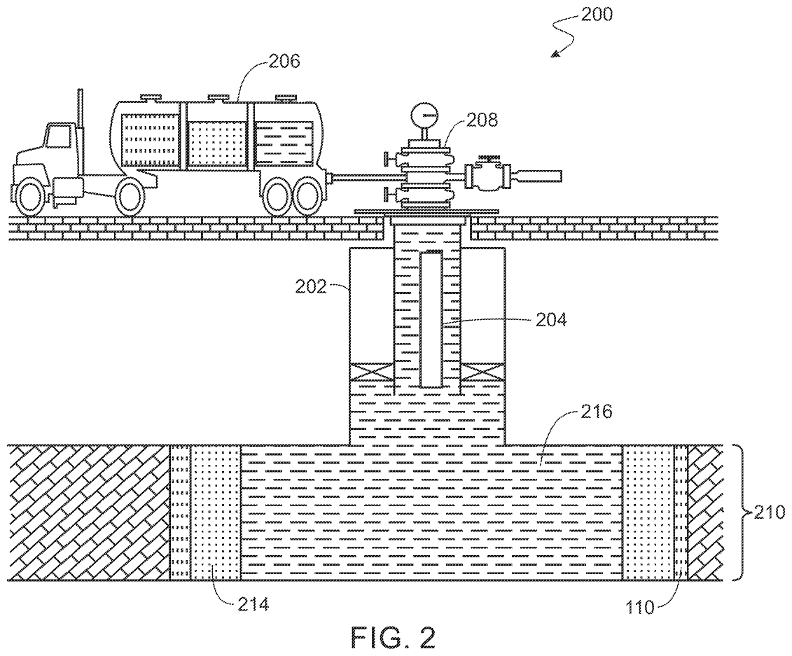

FIG. 2 is a schematic drawing of a scale inhibitor squeeze (SIS) treatment 200 into a wellbore 202 that has an ESP 204 that has been coated with a hydrophobic or super hydrophobic coating. In the SIS treatment, surface equipment 206 is used to inject a series of treating solutions through a wellhead 208 into the wellbore 202.

Squeeze treatments are a common way to apply scale inhibitor downhole. The major advantage of the squeeze technique is that the inhibitor is placed into the reservoir 210, thereby providing protection starting inside the formation. Often the wellbore 202, including inserted components such as the ESP 204, is treated first to remove existing scale. This is usually performed with an acid treatment. An acid treatment fluid is injected into the wellbore 202, and the spent treatment fluid is allowed to return to the surface.

After the treatment fluid, e.g., spent acid and dissolved scale, is allowed to return, pre-flush chemicals 212 are injected. These may include, for example, mutual solvents, clay stabilizers, low concentrations of scale inhibitor, and the like. For example, mutual solvents, such as butyl tri-glycol ether (BTGE) and ethylene glycol monobutyl ether (EGMBE), may enhance inhibitor retention. As used herein, the mutual solvents are miscible in both water and many organic solvents. When included in the pre-flush stage, for example, at a concentration of between about 0.1 vol. % to about 20 vol. %, the mutual solvent can assist in accelerating the well clean-up process and altering the rock from oil-wet to more water-wet. Mutual solvents can also lower the surface tension to minimize water blockage, thus improving the permeability recovered after the treatment.

Pre-flush is primarily used to clean oil from rock surfaces to improve inhibitor adsorption. It also can act as a “spacer” between the formation water and main pill to prevent calcium precipitation, for example, if the inhibitor is incompatible with Ca. In addition, pre-flush can cool the near-wellbore area in high temperature wells, reducing the interaction between the rocks of the formation and the main pill, which helps to allow inhibitor to propagate away from the wellbore.

The scale inhibitor pill 214 is then injected. The scale inhibitor pill 214 is a typically contains one or more scale inhibitors at a concentration of about 5 wt. % to about 20 wt. %, in a solution in seawater, aquifer water, KCl, or filtered produced water. An overflush 216 is used to push the inhibitor several feet away from the wellbore 202, and into the reservoir 210, enhancing the retention of injected inhibitor. The overflush 216 is usually field brine, but may be seawater, aquifer water, a KCl solution, or filtered produced water. The wellbore 202 is shut in for a target period of time, such as several hours to several days, to allow the scale inhibitor to be retained in the formation by adsorbing onto the rock surfaces or by precipitating in the formation and reach near-equilibrium of adsorption or precipitation reactions. This usually occurs as a result of excess calcium. After the target period of time is completed, normal production is resumed and the amount of scale inhibitor in the produced fluids can be monitored.

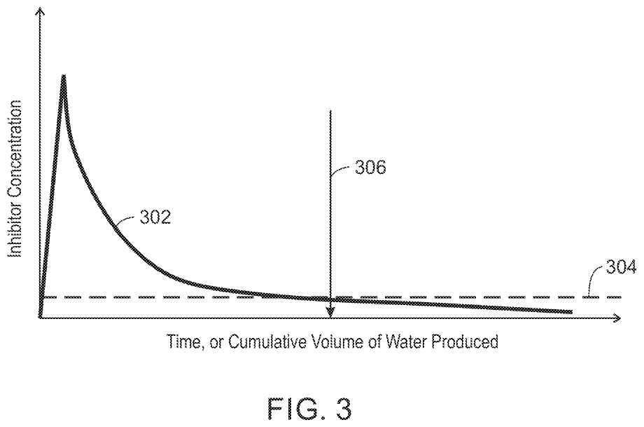

FIG. 3 is a plot 302 of scale inhibitor concentration over time, or cumulative volume of water produced. When production resumes, the inhibitor is produced along with the formation water. Following the SIS treatment, the scale inhibitor flows back first at low concentrations, then increases rapidly in concentration to a peak value, and declines within a few days to a low plateau concentration. Once the concentration reaches the MED 304, the SIS treatment needs to be repeated. This is termed the life 306 of the SIS treatment, herein.

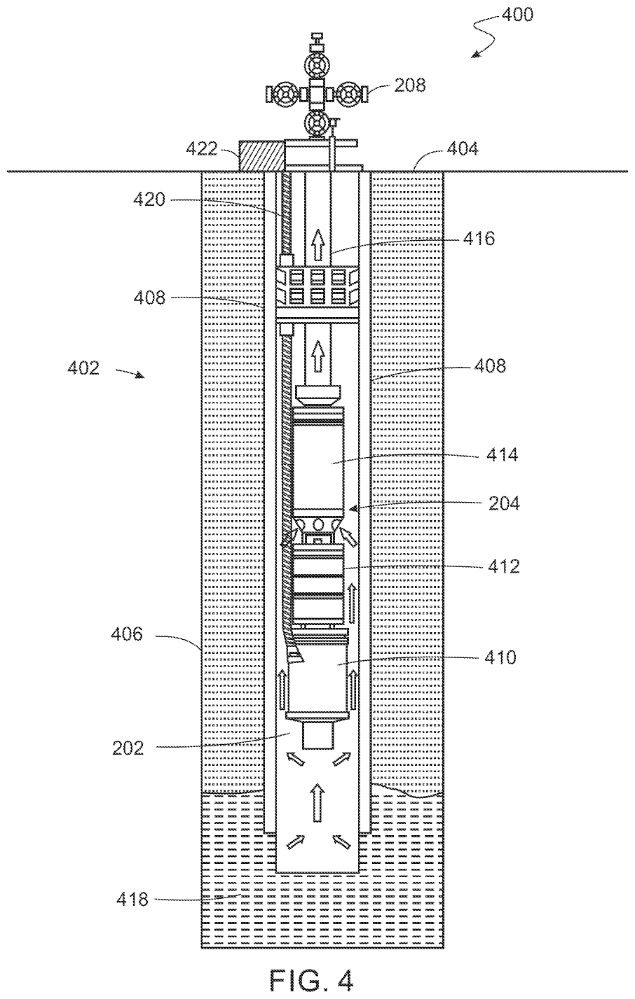

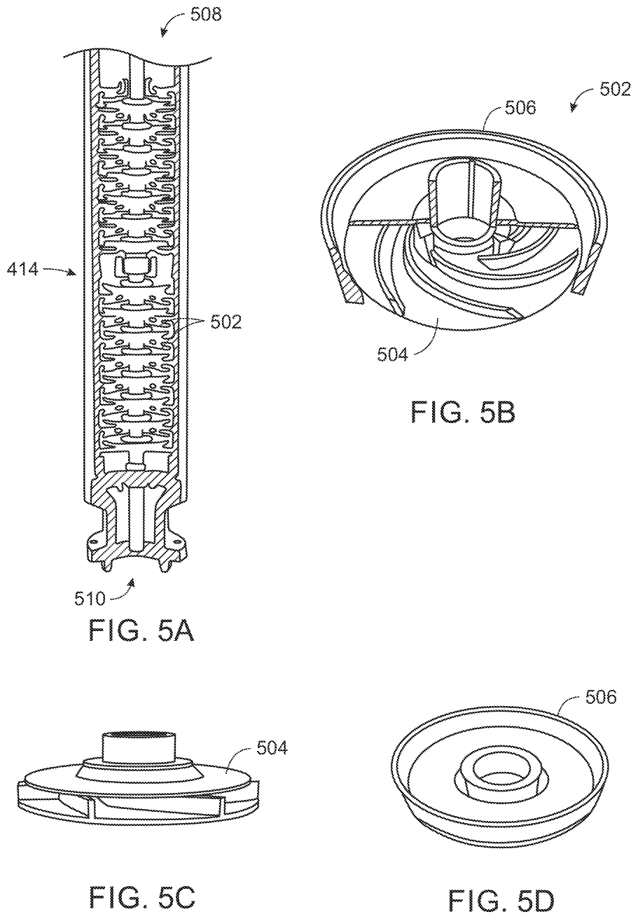

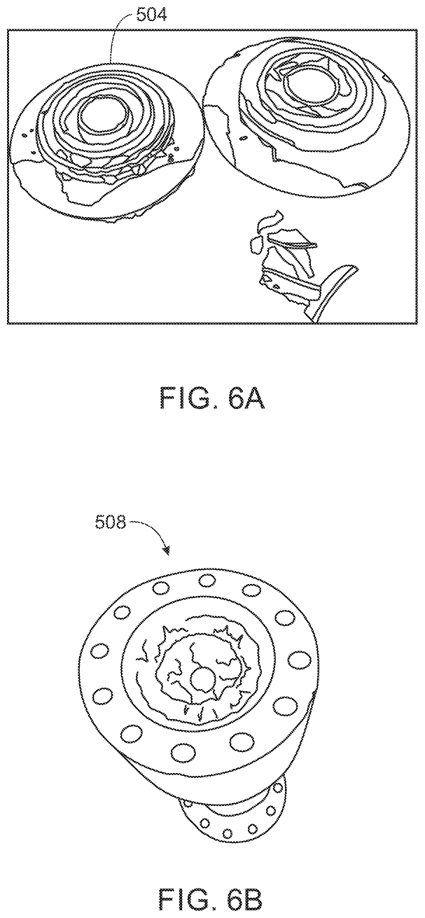

Due to the high direct treatment cost and significant amount of deferred production, extending the life 306 of the SIS treatment is valuable. There are two factors controlling the life 306 of the SIS treatment, the inhibitor return profile shown as the shape of the plot 302 of FIG. 3, and the value of the MED 304. If a very effective inhibitor is used, for example, the MED 304 is low, a long treatment life can be achieved. The ESP is discussed further with respect to FIG. 4. The pump stage, including the elements forming the pump stage, is discussed further with respect to FIGS. 5A-5D. The fouling from scale deposits is discussed further with respect to FIG. 6.

FIG. 4 is a schematic drawing of a system 400 that includes a hydrocarbon-producing well 402 with a portion, the wellhead 208, above the earth's surface 404 and a portion, including the wellbore 202 below the earth's surface 404. Like numbered items are as described with respect to FIG. 2. The wellbore 208 in disposed in an underground formation 406 and includes well casings 408. An ESP 204 is disposed in the wellbore 208 and includes a motor 410, a seal 412 connected to the motor 410, and a pump 414 connected to the seal 412, and tubing 416 connected to the pump 414. The wellbore 202 is in fluid communication with a reservoir 1340 in the underground formation 406. The motor 410 is configured to operate the pump 414, which lifts a produced fluid (e.g., a produced hydrocarbon, produced water) from the reservoir 418 through the tubing 416 to the wellhead 208. The seal 412 equalizes the internal pressure of the motor 410 with that of the well 402, provides a reservoir of high dielectric oil to accommodate the thermal expansion and contraction of the motor oil during the normal cycles of operation and shutdown and transmits mechanical power between the motor 410 and shafts of the pump 414. A power cable 420, connected to a power source 422 or coupling, provides power to the motor 410.

The parts of the ESP 204 that are exposed to the fluids in the wellbore 202, including the motor 410, pump 414, and pump internals, includes a hydrophobic or superhydrophobic coating, such as a DLC coating. A DLC coating includes an amorphous carbon structure which is a mixture of sp³ bonded diamond and graphitic sp² carbon and contains hydrogen atoms. The DLC coating further includes one or more dopants doped into the amorphous carbon structure. In some embodiments, a dopant includes fluorine, oxygen, nitrogen and/or silicon. In general, a dopant alters the surface wettability of the DLC coating so that the dopant-containing DLC coating is hydrophobic, and, in some cases, superhydrophobic. The hydrophobic/superhydrophobic surface of the DLC can reduce the MED of scale inhibitor used to prevent scale formation on the coated parts, relative to hydrophilic surfaces. Without wishing to be bound by theory, it is believed that a fluorinated DLC coating can have a relatively low surface energy and consequently reduce scale adhesion.

In certain embodiments, the DLC coating includes at least 5 (e.g., at least 10, at least 15) atomic percent (at. %) of the dopant(s) and/or at most 20 (e.g., at most 15, at most 10) at. % of the dopant(s).

In certain embodiments, the DLC coating has a contact angle of at least 90° (e.g., at least 100°, at least 110°, at least 120°, at least 130°, at least 140°, at least 150°, at least 160°, at least) 170° and/or at most 180° (e.g., at most 170°, at most 160°, at most 150°, at most 140°, at most 130°, at most 120°, at most 110°, at most) 100°.

In certain embodiments, the DLC coating has a thermal conductivity of at least 400 (e.g., at least 500, at least 600, at least 700, at least 800, at least 900, at least 1000, at least 1100, at least 1200, at least 1300, at least 1400) Wm⁻¹K⁻¹ and/or at most 1500 (e.g., at most 1400, at most 1300, at most 1200, at most 1100, at most 1000, at most 900, at most 800, at most 700, at most 600, at most 500) Wm⁻¹K⁻¹.

In some embodiments, the DLC coating has a hardness of at least 8 (e.g., at least 9, at least 10, at least 11, at least 12, at least 13, at least 14, at least 15, at least 16, at least 17, at least 18, at least 19, at least 20, at least 21, at least 22, at least 23, at least 24) GPa and/or at most 25 (e.g., at most 24, at most 23, at most 22, at most 21, at most 20, at most 19, at most 18, at most 17, at most 16, at most 15, at most 14, at most 13, at most 12, at most 11, at most 10, at most 9) GPa.

The DLC coating can be coated on the motor 410 and pump 414, and other parts of the pump, using any suitable method, such as magnetron sputtering, chemical vapor deposition (CVD), pulsed laser deposition (PLD), direct ion beam, or ion beam assisted cathodic arc deposition. The topography of the DLC coating can be controlled to improve the anti-scaling characteristics. For example, the topography of the coating can be controlled to improve the hydrophobic characteristics. Further, the topography can be adjusted for minimizing the scale nucleation and adhesion, such as by patterning the coating surface into geometrical features with laser beams. Without wishing to be bound by theory, it is believed that smoother surfaces have less tendency for scale deposition. The method for forming the DLC coating may be selected based on the is geometry of the pump stages. The topography of the coating can be controlled to improve the hydrophobic characteristics.

In some embodiments, the thickness of the DLC coating is at least 0.5 (e.g., at least 1, at least 2, at least 3, at least 4, at least 5, at least 6, at least 7, at least 8, at least 9, at least 10, at least 15, at least 20, at least 25, at least 30, at least 35, at least 40, at least 45) μm and/or at most 50 (e.g., at most 45, at most 40, at most 35, at most 30, at most 25, at most 20, at most 15, at most 10, at most 9, at most 8, at most 7, at most 6, at most 5, at most 4, at most 3, at most 2, at most 1) μm.

FIGS. 5A-5D are drawings of a pump 414 used in an ESP. FIG. 5A is a cutaway view of the pump 414 showing that the pump 414 includes stages 502. Like numbered items are as described with respect to FIG. 4. As shown in FIG. 5B, each stage 502 includes an impeller 504 and a diffuser 506. The impeller 504 is shown in FIG. 5C and the diffuser 506 is shown in FIG. 5D. The intake 508 of the pump 414 provides feed to the stages 502, which pushed the liquid through the pump 414 to the discharge 510. Due to high downhole temperature, metallurgy, surface finish and high turbulent flow, the pump 414 is vulnerable to scale deposition, especially on the intake 508, discharge 510, and stages 502, among others.

FIGS. 6A and 6B are images of the scale deposits on the impellers 504 and the pump intake 508. Like numbered items are as described with respect to FIGS. 5A-5D. The scale deposits restrict flow, deteriorate pump performance, and can cause premature failure of the ESP. Further, the high temperature and high turbulence in the pump reduce the inhibitor effectiveness and higher MED value is needed to stop scale in the ESP. This leads to a shortened life for the SIS treatment.

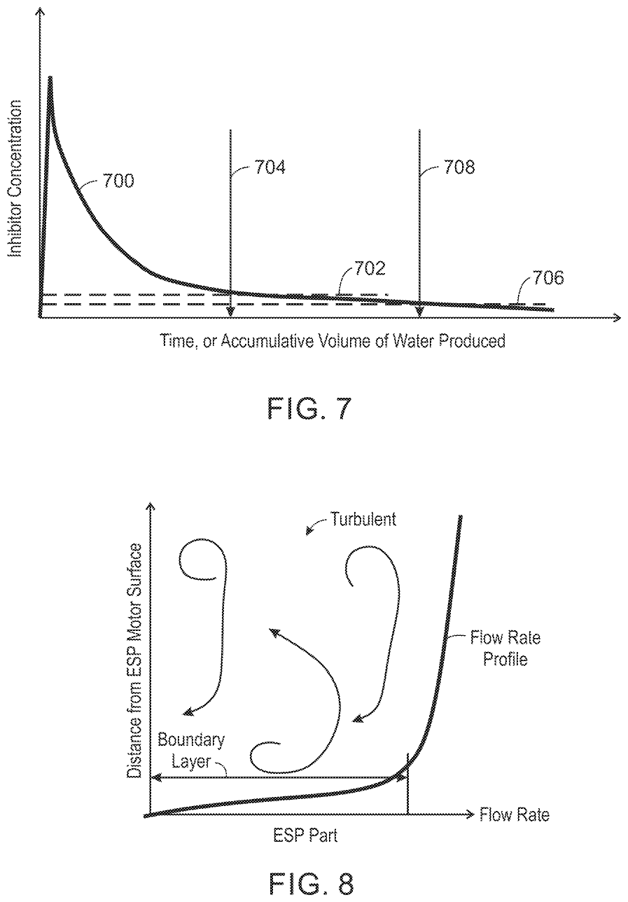

FIG. 7 is a plot showing the reduction in the MED resulting from coating the parts of the ESP with a hydrophobic or super hydrophobic coating. The inhibitor concentration 700 falls off at the same rate in either case. After the initial flowback, the residual concentration of scale inhibitor typically decreases with time (or produced water volume) very slowly. Thus, even a small reduction in MED value can translate to a significant increase in treatment life. For an uncoated ESP, the MED is at a first level 702 resulting in a relatively short lifespan 704 for the SIS treatment. A hydrophobic or superhydrophobic coating can be applied to the parts of the ESP that are exposed to the wellbore fluids, such as the pump stages, intake, discharge, and the like, on which inorganic scale deposition is prone to occur. This lowers the MED to a second level 706. As the inhibitor concentration 700 falls off very slowly, the lifespan 708 of the SIS treatment is substantially increased. Accordingly, inorganic scale deposits on ESP pump parts can be effectively eliminated using less treatment chemicals.

FIG. 8 is a plot of the water flow velocity profile for a turbulent boundary layer in a pump. Although the produced fluids are in turbulent flow regime inside of the ESP, there is a boundary layer adjacent to the surface of ESP parts, in which the water flow rate is slow. This layer acts as an incubator for the formation of scale-nucleation and deposition. By applying a hydrophobic or superhydrophobic coating, the boundary layer is reduced and the contact of produced water with the pump components is minimized.

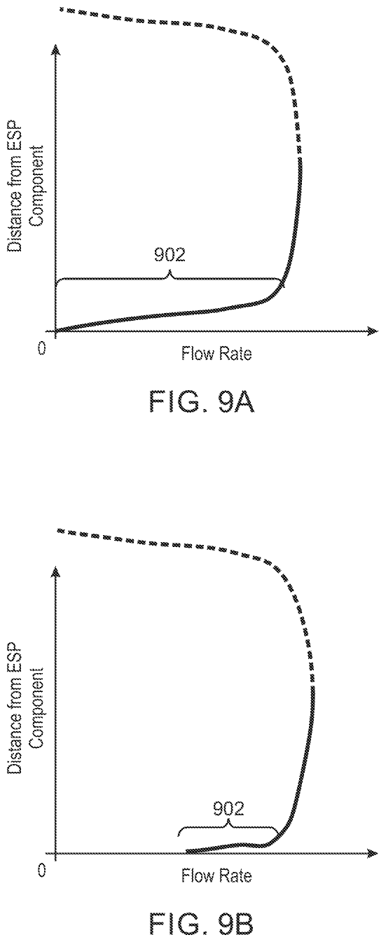

FIGS. 9A and 9B are plots of the water flow velocity in a turbulent boundary layer with hydrophilic and hydrophobic surfaces. FIG. 9A is plot of the flow rate profile for a hydrophilic surface, such as uncoated steel. FIG. 9B is the flow rate profile with a hydrophobic surface coating, such as DLC.

Unlike the hydrophilic surface which has an affinity to water, water slips on the hydrophobic surface. As a result, the boundary layer 902 is significantly reduced and the water flow rate in the boundary layer is much higher than that with the hydrophilic steel. This helps with scale control in a number of ways. For example, if the residence time of water in the boundary layer is shorter than the nucleation induction time, scale particles will not be formed on the coated surfaces of the ESP. If the residence time is still longer than the nucleation induction time, nucleation process can be kinetically prevented by the reduced scale inhibitor concentration. Further, scale particles, if formed in the boundary layer or bulk solution, may be swept away from the ESP components due to higher water speed at the surface, rather than attaching to the surface. In multiphase fluids, such as fluids containing combinations of water, oil, and gas, a gas or oil layer may form between the coated ESP surface and water, which can eliminate the scaling process.

This also prevents corrosion and erosion of the ESP surfaces, as the coating will be smooth and free of corrosion products. Such a surface is less likely to provide nucleation sites for the formation of nuclei or places for scale particles formed in bulk water to attach. The irregular shaped particles due to scale inhibitor further diminish the attachment. Even the less deformed particles, formed at reduced inhibitor concentrations, are unlikely to deposit on the coated surface.

As described herein, in some embodiments, the hydrophobic coatings are made of glass, modified ceramics, polymers such as polytetrafluoroethylene (PTFE), epoxy resins, and the like. However, these coating materials can be removed by erosion or delamination, becoming ineffective.

Thus, in some embodiments, the hydrophobic coating used for the ESP pump components is a diamond-like carbon (DLC). DLC is chemically inert, has a high resistance to wear and corrosion, and strong adhesion to steel substrate. Further, as described herein, the DLC can be modified to increase its hydrophobic properties.

### Examples

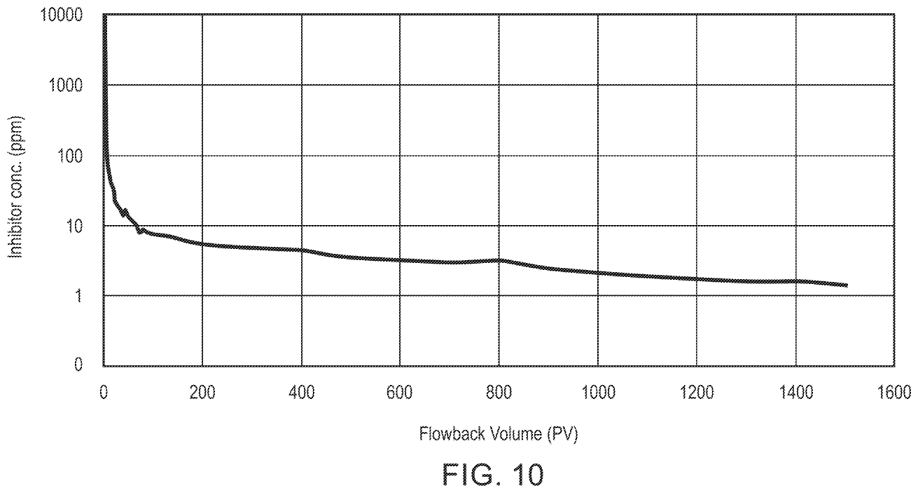

FIG. 10 is a plot of the scale inhibitor return profile in packed column test. The packed column method simulates the scale inhibitor return profile after SIS treatment. The column was packed with sieved crushed limestone particles (size 0.5-1 mm or 18-40 mesh) and the test was conducted at 93° C.

TABLE 1
Synthetic brine composition used for packed column test

| Parameter | Concentration (mg/L) |
|---|---|
| Sodium | 23977 |
| Potassium | 891 |
| Magnesium | 1400 |
| Calcium | 7700 |
| Chloride | 54024 |
| Sulfate | 532 |

In FIG. 10, the concentration of the scale inhibitor decreased to 5 ppm after ˜250 PV (pore volume), 4 ppm after ˜420 PV, 3 ppm after ˜700 PV, and 2 ppm after ˜1050 PV. Pore volume is the empty space inside of porous rock. In these examples, it is the empty space between the carbonate solids packed inside of column.

The impact of the coating on the lifespan of the SIS treatment will have a number of effects on the MED. By reducing MED value from 5 ppm (without coating) to 4 ppm, 3 ppm and 2 ppm (with coating), the lifespan of the SIS treatment will increase, respectively, 68%, 180%, and 320%. By reducing MED value from 4 ppm (without coating) to 3 ppm and 2 ppm (with coating), the lifespan of the SIS treatment will increase 67% and 150%, respectively. By reducing MED value from 3 ppm (without coating) to 2 ppm (with coating), the lifespan of the SIS treatment will increase 50%.

### EMBODIMENTS

An embodiment described herein provides a system for reducing scale inhibitor demand for protecting an electrical submersible pump (ESP) for downhole service in a wellbore. The system includes a motor including a housing that houses a motor stator. The system also includes a pump intake coupled to a pump stage, wherein the pump stage includes an impeller and a diffuser, wherein the pump stage is operatively coupled to the motor stator. A substantially hydrophobic coating substantially covers each surface of the motor, motor stator, housing, pump stage, impeller, and diffuser, that is in direct contact with fluids in the wellbore.

In an aspect, combinable with any other aspect, the motor further includes a motor head, or a motor base.

In an aspect, combinable with any other aspect, the hydrophobic coating includes a polymer selected from the group consisting of polytetrafluoroethylene (PTFE), fluorinated ethylenepropylene (FEP), perfluoro alkoxy (PFA), phenolics, polyether ether ketone (PEEK), and polyphenylene sulfide (PPS).

In an aspect, combinable with any other aspect, the hydrophobic coating includes a ceramic.

In an aspect, combinable with any other aspect, the hydrophobic coating includes a diamond-like carbon coating. In an aspect, the diamond-like carbon coating includes a dopant.

In an aspect, the dopant includes at least one member selected from the group consisting of fluorine, oxygen, nitrogen, and silicon.

In an aspect, the diamond-like carbon coating includes from 5 atomic percentage (at. %) to 20 at. % of the dopant.

In an aspect, a contact angle for the diamond-like carbon coating is from 90° to 180°.

In an aspect, a thickness of the diamond-like carbon coating is from 0.5 μm to 50 μm.

In an aspect, the diamond-like carbon coating has a thermal conductivity of from 400 Wm⁻¹K⁻¹ to 1500 Wm⁻¹K⁻¹.

In an aspect, the diamond-like carbon coating has a hardness of from 8 GPa to 25 GPa.

In an aspect, further including a produced hydrocarbon, wherein the produced hydrocarbon forms a film between a produced water and the diamond-like carbon coating.

In an aspect, combinable with any other aspect, the system includes a scale inhibitor applied by a scale inhibitor squeeze (SIS) treatment.

Another embodiment described herein provides a method for extending scale inhibitor squeeze (SIS) treatment life in an electric submersible pump (ESP). The method includes performing an SIS treatment through the ESP, wherein the ESP includes a motor including a housing that houses a motor stator, and a pump intake coupled to a pump stage. The pump stage includes an impeller and a diffuser, wherein the pump stage is operatively coupled to the motor stator. A hydrophobic coating substantially covers each surface of the motor, motor stator, housing, pump stage, impeller, and diffuser, that is in direct contact with fluids in the wellbore. The concentration of the scale inhibitor is monitored in the produced fluids and the SIS treatment through the ESP is repeated when the scale inhibitor concentration falls below a minimum effective dose (MED). The MED is decreased by the hydrophobic coating by about 20% to about 80%.

In an aspect, combinable with any other aspect, the method includes applying the hydrophobic coating in a dip coating process.

In an aspect, combinable with any other aspect, the hydrophobic coating is a diamond-like carbon (DLC).

In an aspect, the DLC is applied by magnetron sputtering, chemical vapor deposition (CVD), pulsed laser deposition (PLD), direct ion beam, and ion beam assisted cathodic arc deposition.

In an aspect, the method includes doping the DLC with an element selected from the group consisting of fluorine, oxygen, nitrogen, and silicon.

In an aspect, the hydrophobic coating is a structure including diamond-like carbon (DLC) and a second material. In an aspect, the second material includes zinc oxide, titanium dioxide nanorods, or both.

Other implementations are also within the scope of the following claims.

What is claimed is:

1. A system for reducing scale inhibitor demand for protecting an electrical submersible pump (ESP) for downhole service in a wellbore comprising:
a motor comprising a housing that houses a motor stator;
a pump intake coupled to a pump stage, wherein the pump stage comprises:
an impeller; and
a diffuser, wherein the pump stage is operatively coupled to the motor stator; and
a hydrophobic coating substantially covering each surface of the motor, motor stator, housing, pump stage, impeller, and diffuser, that is in direct contact with fluids in the wellbore.

2. The system of claim 1, wherein the motor further comprises a motor head, or a motor base.

3. The system of claim 1, wherein the hydrophobic coating comprises a polymer selected from the group consisting of polytetrafluoroethylene (PTFE), fluorinated ethylenepropylene (FEP), perfluoro alkoxy (PFA), phenolics, polyether ether ketone (PEEK), and polyphenylene sulfide (PPS).

4. The system of claim 1, wherein the hydrophobic coating comprises a ceramic.

5. The system of claim 1, wherein the hydrophobic coating comprises a diamond-like carbon coating.

6. The system of claim 5, wherein the diamond-like carbon coating comprises a dopant.

7. The system of claim 5, wherein the dopant comprises at least one member selected from the group consisting of fluorine, oxygen, nitrogen, and silicon.

8. The system of claim 5, wherein the diamond-like carbon coating comprises from 5 atomic percentage (at. %) to 20 at. % of the dopant.

9. The system of claim 5, wherein a contact angle for the diamond-like carbon coating is from 90° to 180°.

10. The system of claim 5, wherein a thickness of the diamond-like carbon coating is from 0.5 μm to 50 μm.

11. The system of claim 5, wherein the diamond-like carbon coating has a thermal conductivity of from 400 Wm⁻¹K⁻¹ to 1500 Wm⁻¹K⁻¹.

12. The system of claim 5, wherein the diamond-like carbon coating has a hardness of from 8 GPa to 25 GPa.

13. The system of claim 5, further comprising a produced hydrocarbon, wherein the produced hydrocarbon forms a film between a produced water and the diamond-like carbon coating.

14. The system of claim 1, further comprising a scale inhibitor applied by a scale inhibitor squeeze (SIS) treatment.

15. A method for extending scale inhibitor squeeze (SIS) treatment life in an electric submersible pump (ESP), comprising:
performing an SIS treatment through the ESP, wherein the ESP comprises:
a motor comprising a housing that houses a motor stator;
a pump intake coupled to a pump stage, wherein the pump stage comprises:
an impeller; and
a diffuser, wherein the pump stage is operatively coupled to the motor stator; and
a hydrophobic coating substantially covering each surface of the motor, motor stator, housing, pump stage, impeller, and diffuser, that is in direct contact with fluids in the wellbore; and
monitoring the concentration of the scale inhibitor in the produced fluids; and
repeating the SIS treatment through the ESP when the scale inhibitor concentration falls below a minimum effective dose (MED), wherein the MED is decreased by the hydrophobic coating by about 20% to about 80%.

16. The method of claim 15, comprising applying the hydrophobic coating in a dip coating process.

17. The method of claim 15, wherein the hydrophobic coating is a diamond-like carbon (DLC).

18. The method of claim 17, wherein the DLC is applied by magnetron sputtering, chemical vapor deposition (CVD), pulsed laser deposition (PLD), direct ion beam, and ion beam assisted cathodic arc deposition.

19. The method of claim 17, comprising doping the DLC with an element selected from the group consisting of fluorine, oxygen, nitrogen, and silicon.

20. The method of claim 15, wherein the hydrophobic coating is a structure comprising diamond-like carbon (DLC) and a second material.

21. The method of claim 20, wherein the second material comprises zinc oxide, titanium dioxide nanorods, or both.
